(19) United States
(12) Patent Application Publication
(10) Pub. No.: US 2011/0240928 A1
(43) Pub. Date: Oct. 6, 2011

(54) Composites with high photoquenching factor of electroconduction based on polymer-metalorganic compounds

(75) Inventors: Mirza Abdul Oglu Kurbanov, Baku (AZ); Gulmammed Ziyaddin Oglu Suleymanov, Baku (AZ); Azad Agalar Oglu Bayramov, Baku (AZ); Nuru Arab Oglu Safarov, Baku (AZ); Aynura Fizuli Gizi Gochueva, Baku (AZ)

(73) Assignee: MALAXIT Co.

(21) Appl. No.: 12/751,967

(22) Filed: Mar. 31, 2010

(51) Int. Cl. H01C 13/00

(52) U.S. Cl. 252/501.1

(57) ABSTRACT

A composite material with a high photoquenching factor of electroconductivity comprising a multiple-component system which is a combination of a polymeric material matrix and a ferrocene-type compound contained in the polymeric material matrix. In one or more aspects of the invention, the polymer material matrix may be formed with polypropylene, high-density polyethylene, low-density polyethylene, polyvinyl alcohol, polyvinyl chloride, polyvinylidene fluoride, or a copolymer of vinylidene chloride and trifluoroethylene. Additionally, the ferrocene-type compound may be contained in the composite in an amount of 10 vol. % to 50 vol. % per 100 vol. % of the matrix, an, depending on the type of the polymer used as a matrix and on the content of the ferrocene-type compound in the matrix, the R_{f}/R₀ ratio, where R_{f} is electrical resistance of the composite under illumination conditions, and R₀ is electrical resistance of the composite without illumination, may be increase under illumination with a factor of up to 960.

### FIELD OF THE INVENTION

This invention relates to photoelectric composite materials, more particularly to photoelectric composite materials with a high photoquenching effect, i.e., to composite materials with negative photoconductivity.

### BACKGROUND OF THE INVENTION

Known in the art are a photoresistor composition and a photoresistor using this composition, which are described in Japanese Unexamined Patent Application Publication H03-160,328 issued on Jul. 10, 1991 (inventors Hiroshi Sasaki, et al.). The invention is aimed at an increase in change of a resistance value due to the irradiation with ultraviolet rays by using a composition containing a specific spiropyrane compound. This composition is composed of a light permeable organic polymer material containing a spiropyrane compound, preferably a spiropyrane compound represented by formula I or/and formula II.

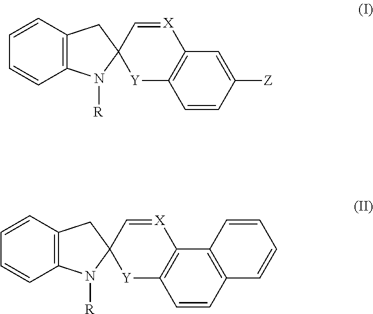

The composition exhibits different resistivities depending on the wavelength of incident light (e.g., ultraviolet rays and visible light). In the formulae, R is 4-20 C (branched) alkyl or a benzene ring having a predetermined group between R and N, X is CH or N, Y is O or S and Z is H or nitro. The composition can be formed from the compound of the formula I or II, a polyvinyl chloride as the polymer material and o-nitrophenyloctyl ether as a plasticizer.

However, the composite described in the above-mentioned patent publication changes light-induced conductivity in a positive direction. In other words, as intensity of the incident light increases, the conductivity also increases. This means that the composite of Japanese Unexamined Patent Application Publication H03-160,328 does not possess a photoquenching effect that may be needed in electronic, radioelectronic and acoustoelectronic device for providing fast response and effective non-contact commutation of electronic circuits.

The article “Unusual Photoelectric Properties of Polymeric Composites Containing Heteropolynuclear Complexes of Transition Metals” published by N. A. Davidenko, et al. in Semiconductors, 2006, Vol. 40, No. 2, pp. 240-248, describes composites which are synthesized based on acrylonitrilebutadienestyrene and poly-N-epoxypropylcarbazole doped with heteropolynuclear copper complexes. The study showed that the absorption and internal photoelectric effect in the visible region of the spectrum are controlled by the d-d transitions of Cu (II) ions. Positive and anomalous negative photoconductivity effects were detected in films of these composites. Unusual photoelectric properties can be caused by nonequilibrium-carrier capture by deep traps near the boundaries of the associations of structurally different complexes. The negative photoconductivity effect is leveled, and film photosensitivity increases as an additional channel of excess hole transport is formed using poly-N-epoxypropylcarbazole. In the authors' opinion, the new composite material is characterized by simplicity of the manufacturing, comparatively high factor of electroconductivity photoquenching of the composite, and structural simplicity.

However, a photoelectric composite material, based on polar and nonpolar thermoplastic polymers doped with ferrocene particles, with photoconductivity that is reduced under the effect of incident light, i.e., with high light-induced photoquenching of conductivity, is unknown in the art.

### BRIEF SUMMARY OF INVENTION

Accordingly, it is an object of the present invention to provide a composite material with a high photoquenching effect of electroconductivity based on polymer-organometallic compounds. It is another object to provide the aforementioned composite material that has a simple composition and can be produced in a simple manner with advanced technology on the basis of various polymer matrices.

The photoelectric composite material of the invention with a high light-induced photoquenching effect comprises a polymer and a organometallic compound known as ferrocene that is expressed by the following formula: Fe(C₅H₅)₂. It is the prototypical metallocene, a type of organometallic chemical compound comprising two cyclopentadienyl rings bound on opposite sides of a central metal atom. Such organometallic compounds are also known as sandwich compounds.

The polymer may comprise, e.g., a high-density polyethylene or a fluorine-containing polymer. The fluorine-containing polymer may comprise a copolymer of vinylidene chloride with a fluorine-containing polymer, e.g., such as trifluoroethylene (F42).

Composites of the invention with a high photoquenching factor of electroconductivity based on polymer-organometallic compounds are designed for use in controlled photoelectric instruments, in particular, in effective non-contact circuit switching units of electronic devices and electrical-type systems of various purposes. At the same time, photoelectric materials with photoquenching of electroconductivity can be produced on the basis of low-temperature technology that is a distinct from conventional technique.

The photoelectric composite of the invention can be prepared on the basis of different polymeric matrices. The manufacturing procedure is simple since it uses starting materials in the form of powdered polymers and monocrystalline organometallic compounds.

The composites of the invention have the following characteristics:
if the composite consists of a high-density polyethylene matrix that contains 20 to 40 vol. % of ferrocene, the photoquenching factor of electroconductivity is in the range 150 to 650; and
if the composite consists of a polyvinylidenefluoride matrix that contains 20 to 40 vol. % of ferrocene, the photoquenching factor of electroconductivity is in the range 5 to 120.

### BRIEF DESCRIPTION OF THE DRAWINGS

FIG. 1 is a graph illustrating an effect of ferrocene content on R_{f}/R₀ ratio in example photoelectric composite materials with negative photoconductivity prepared from high-density polyethylene and ferrocene, wherein volume content of the ferrocene in composite is varied in the range of 10% to 50%, and the content of the high-density polyethylene is 90% to 50%.

FIG. 2 is a graph illustrating an effect of ferrocene content on R_{f}/R₀ ratio in example photoelectric composite materials with negative photoconductivity prepared on the basis of polyvinylidene fluoride and ferrocene, wherein volume content of the ferrocene in composite is varied in the range of 10% to 50%, and the content of the polyvinylidene fluoride is 90% to 50%.

FIG. 3 is a graph illustrating an effect of incident light on electrical resistance of specimens prepared from photoelectric composite materials with negative photoconductivity comprising 80 vol. % of high-density polyethylene and 20 vol. % of ferrocene.

FIG. 4 is a graph illustrating an effect of incident light on electrical resistance of specimens produced from photoelectric composite materials with negative photoconductivity comprising 80 vol. % polyvinylidene fluoride and 20 vol. % ferrocene.

FIG. 5 is a graph illustrating the spectral dependence of photoquenching of electroconductivity for composites of 80 vol. % high-density polyethylene and 20 vol. % ferrocene and for composites of 80 vol. % polyvinylidene fluoride and 20 vol. % ferrocene measured at a given light intensity of 4000 W/m².

### DETAILED DESCRIPTION OF THE INVENTION

According to one of several aspects of the invention, the photoelectric composite material with a high light-induced photoquenching factor comprises a polymeric material matrix and an organometallic compound contained in the polymeric material matrix and known as ferrocene that is expressed by the following formula: Fe(C₅H₅)₂. It is a prototypical metallocene, a type of organometallic chemical compound consisting of two cyclopentadienyl rings bound on opposite sides of a central metal atom.

The polymer may comprise, e.g. a high-density polyethylene or a fluorine-containing polymer, such as polyvinylidene fluoride. Other examples include polyvinylchloride, polypropylene, polyvinyl alcohol, copolymer of vinylidene chloride with trifluoroethylene, and low density polyethylene.

Ferrocene and oxygen-containing derivatives of ferrocene may be used as active phases. An example of a chemical structure of ferrocene is shown below by formula (1), and examples of chemical structures of oxygen-containing derivatives of ferrocene are shown by formulas (2) and (3). Oxygen-containing derivatives of ferrocene differ from each other only by spatial position of OH groups relative to iron atom.

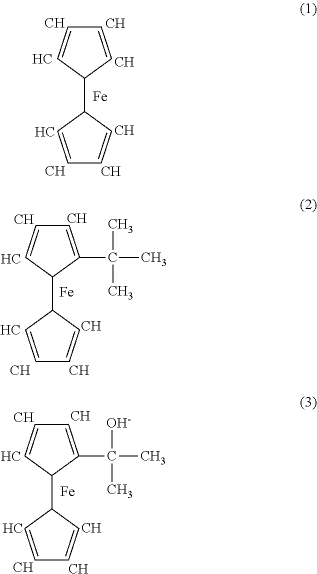

For the purposes of the present invention, the ferrocenes and ferrocene derivatives will be designated by a common term “ferrocene-type compounds”.

The chemical formula of ferrocene is [Fe(C₅H₅)₂]. The ferrocene is one of the most known organometallic compounds. In a molecule of ferrocene an atom of iron is connected with all carbon atoms. It was revealed that an atom of ferrocene is between two high symmetric five-membered rings. The carbon-carbon bond distances are 1.40 Å within the five-membered rings, and the Fe—C bond distances are 2.04 Å. The Fe—C bond in ferrocene is nonreactive and is broken only by very strong deoxidizing agents: hydrogen in presence of a catalyst (e.g., Raney nickel) (300° C., 2.5 MPa), or solutions of alkaline metals in liquid ammonia or amines.

Ferrocene—dicyclopentadiene ferrum—is an orange-colored crystal substance. The melting point of ferrocene is 173° C. The ferrocene molecule has a sandwich structure called so because an iron ion is sandwiched between two five-membered carbon rings. Electronic configuration of iron is 3d⁶₄S². The rings revolve freely relatively each of other around an axis connecting centers of rings and penetrating through iron atom.

Ferrocene is lightly and reversibly oxidized till the state of a cation-radical of ferrocene (by oxygen of air in acid medium, hydrogen peroxide, iodine, iron trichloride (III), etc.). Oxidation does not cause noticeable changes in geometry of the ferrocene molecule. Diluted solutions of ferrocene salts are blue in color, and concentrated solutions of ferrocene salts are red in color.

In one or several aspects of the present invention, high-density polyethylene is used as thermoplastic nonpolar polymer. Such polymers have an amorphous-crystalline structure. A melting point of this high-density polyethylene is 433 K. Due to carbon-carbon and carbon-hydrogen covalent bonds, high density polyethylene is a stable material and relatively reactive.

A supramolecular structure of polyethylene changes appreciably during dispersion by single-crystal particles of ferrocene. Dispersion of ferrocene particles into polyethylene reduces decrease crystallinity. By varying a temperature-time mode, it is possible to bring crystallinity to 95%.

Polar fluorine-containing polymer polyvinylidene fluoride is also applicable as a matrix material for the purposes of the invention. Polyvinylidene fluoride is an amorphous-crystalline polymer. It has a dipole moment because of the presence of a carbon-fluoride bond in a monochain. Depending on the supramolecular structure, the melting point of polyvinylidene fluoride ranges from 443K to 493K.

Polarity of polyvinylidene fluoride provides stronger inter-phase interaction on the boundaries of ferrocene particles and polymer chains than those of matrices in case of matrixes represented by nonpolar polymers such as a high-density polyethylene.

According to one or several aspects of the invention, a nonpolar polymer, e.g., a nonpolar polypropylene, is also applicable for use as a matrix of the proposed photoelectric composite material doped with the ferrocene-type compound. Polypropylene has physical and mechanical properties which are substantially the same as those of polyethylene. However, the presence of side CH₃ groups in the molecular chain slightly decreases the amorphism of the physical structure and enhances molecular mobility. As with high density polyethylene, diffusion of ferrocene particles into polypropylene leads to amorphization of the of polypropylene. By varying the temperature-time mode, it is possible to bring the maximum crystallinity of the polymer down to 60%.

An alternative material suitable for forming a polar polymer matrix in the composite material of one or several aspects of the invention is polyvinylchloride. As in the case of polyvinylidene fluoride, the use of polyvinylchloride as a polar polymer matrix increases interfacial interaction between ferrocene-based compound particles contained in the matrix and polymer chains. The polarity of this polymer is determined by the presence of C—Cl bonds in the polymer chains.

Ferrocene is synthesized in the form of single crystals. Prior to doping into the polymer matrix, the monocrystals are crushed to a particle size ranging from 5 to 20 μm. The upper limit of content of ferrocene (≦50 vol. % per 100 vol. % of the matrix) is defined by deterioration of physical and mechanical properties of the composite. If the content of the ferrocene exceeds 50 vol. % per 100% of the matrix, the composite becomes fragile and loses its mechanical strength. The lower limit of the ferrocene content is 10 vol. % per 100 vol. % of the matrix. If the content of ferrocene is below 10 vol. %, the effect of conductivity photoquenching will be too low.

Another material suitable for use as a polar polymer matrix of the composite material of the invention is a copolymer of vinylidene fluoride and tripfluoroethylene, e.g., of F42 type. This material is chosen because its melting point is slightly higher than the decomposition temperature of ferrocene derivatives. This allows revealing of the role of the ferrocene derivatives in the photoquenching effect manifested by the composite material of the invention.

Yet another material suitable for use as a polar polymer matrix of the composite material of one or several aspects of the invention is a polyvinyl alcohol, which, similar to the case of organic ferrocene derivatives, includes in its structure a hydroxyl group OH⁻ (see formulas (2) and (3) above). As earlier mentioned, ferrocene and its oxygen-containing organic derivatives are used as an active phase. Oxygen-containing components of the ferrocene differ from each other only by positions relative to atoms of iron.

For preparation of the photocomposite material of the invention, a polymer powder is mechanically mixed with a ferrocene-type organometallic compound until the mixture becomes homogeneous. The polymer powder may have dimensions in the range of 10 μm to 200 μm, and ferrocene is used in the form monocrystalline particles having dimensions of 5 μm to 20 μm. Mixing is carried out, e.g., at a room temperature for 15 minutes with the use of vibrating mill.

The mixture is then tabletized, and the tablets are subjected to the action of temperature and pressure. For example, first, the pressure may be established at about 5 atmospheres and the tablets heated to the melting point of the polymer phase. The material heated to the melting point may be kept at 5 atmospheres for 10 minutes. Next, the pressure of the obtained sample may be increased to 150 atmospheres, the sample is held under this condition for 5 minutes and is then quenched in water. If necessary, the sample may be naturally cooled in air.

To measure photoelectric conductivity of the obtained sample, an electrode may, for instance, be placed onto the surface of the sample, and the electrodes irradiated with a light having intensity of 10÷4000 W/m².

In the context of the present invention, the light-induced conductivity photoquenching effect is represented by a R_{f}/R₀ ratio, where R_{f} is electrical resistance of the composite under illumination conditions, and R₀ is electrical resistance of the composite without illumination. The higher the ratio, the greater the photoquenching effect.

Based on the results of measurements, the following relationships were investigated:
effect of volumetric content of ferrocene on R_{f}/R₀ ratio in a photocomposite which is based on a high-density polyethylene as a polymer matrix;
effect of volumetric content of ferrocene on R_{f}/R₀ ratio in a photocomposite which is based on a polyvinylidene fluoride as a polymer matrix;
effect of irradiation intensity on a photoresistance in a composite based on the use of a high-density polyethylene matrix;
effect of irradiation intensity on a photoresistance in a composite based on the use of polyvinylidene fluoride matrix;
spectral dependence of photoquenching of electroconductivity at a given light intensity of 4000 W/m².

### Example 1

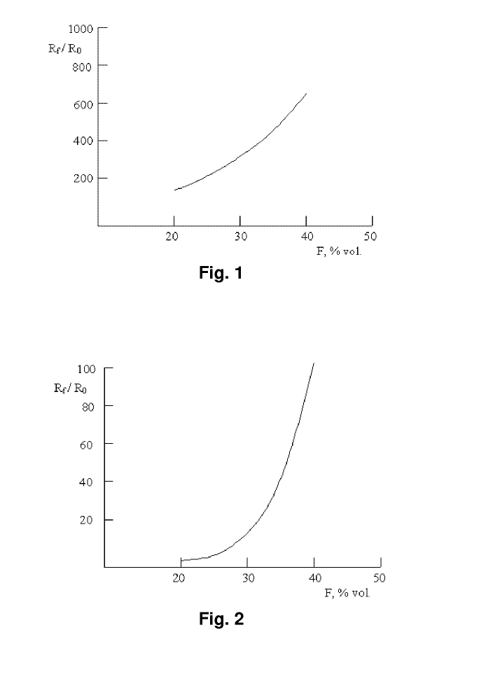

Photoelectric composite materials with negative photoconductivity were prepared from high-density polyethylene and ferrocene. Volume content of the ferrocene in composite was varied in the range of 10% to 50%, and the content of the high-density polyethylene was 90% to 50%. An effect of the ferrocene content on the R_{f}/R₀ ratio is shown in FIG. 1.

In this graph, the content (vol. %) of ferrocene F is plotted on the abscissa axis, and the R_{f}/R₀ ratio is plotted on the ordinate axis. The samples were illuminated with visible light at an intensity of 4000 W/m². As shown in FIG. 1, when the specimens were illuminated under the above conditions, their electrical resistance was increased 150 to 700 times, and hence, the conductivity decreases by the same factor. This confirms that the composition material of the invention may provide a strong negative photoconductivity effect).

### Example 2

Photoelectric composite material with negative photoconductivity was prepared on the basis of polyvinylidene fluoride and ferrocene. Volume content of the ferrocene in composite was varied in the range of 10% to 50%, and the content of the polyvinylidene fluoride was 90% to 50%. An effect of the ferrocene content on the R_{f}/R₀ ratio is shown in FIG. 2.

As shown in FIG. 2, when the specimens were illuminated with visible light at an intensity of 400 W/m², their electrical resistance was increased 5 to 120 times, and conductivity decreased by the same factor.

### Example 3

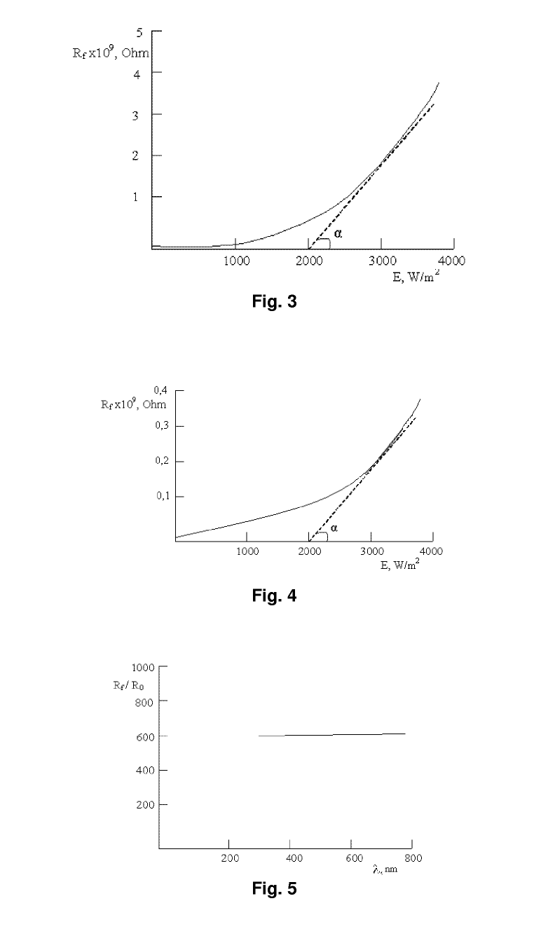

Photoelectric composite materials with negative photoconductivity comprising 80 vol. % of high-density polyethylene and 20 vol. % of ferrocene were prepared, and the effect of characteristics of the incident light on electrical resistance of specimens prepared from the composite material was investigated. The results are shown in FIG. 3.

Here:

$$α = \frac{ Δ {R}_{f}}{Δ E} = 18.85 \times {10}^{5} \frac{Ohm \times {m}^{2}}{W}$$

is a ratio of the change in resistance to a change in the intensity of the incident light. It can be seen from FIG. 3 that the photoresistance of the specimen to a great extent depends on intensity E of the incident light, and that depending on the value of E, the resistance grows exponentially.

### Example 4

Photoelectric composite materials with negative photoconductivity comprising 80 vol. % polyvinylidene fluoride and 20 vol. % ferrocene were prepared, and the effect of characteristics of the incident light on electrical resistance of specimens produced from the composite material was investigated. The results are shown in FIG. 4.

Here,

$$α = \frac{ Δ {R}_{f}}{Δ E} = 2.1 \times {10}^{4} \frac{Ohm \times {m}^{2}}{Vt}$$

### Example 5

The spectral dependence of photoquenching of electroconductivity for composites of 80 vol. % high-density polyethylene and 20 vol. % ferrocene and for composites of 80 vol. % polyvinylidene fluoride and 20 vol. % ferrocene was measured at a given light intensity of 4000 W/m². The results of investigations are shown in FIG. 5. It can be seen from FIG. 5 that the conductivity photoquenching effect of the composites remains practically the same across the entire range of the visible light.

### Example 6

R_{f}/R₀ ratios for composites based on the polypropylene, polyvinyl alcohol, low-density polyethylene, polyvinylchloride, and a copolymer of vinylidene chloride with trifluoroethylene containing ferrocene in an amount of 20 vol. % to 50 vol. % are shown below in Table 1. The conductivity photoquenching effect was revealed in all composites. However, polar polymers are characterized by noticeably lower values of R_{f}/R₀ than in nonpolar polymers. Results of the tests showed that the R_{f}/R₀ ratio also depends on the melting points of polymer matrixes, and, hence, on the temperature at which the composites based on these polymers were pressed. Thus, an increase in the temperature of pressing leads to a decrease of the R_{f}/R₀ ratio. In a first approximation, this may be associated with irreversible changes that occur in the chemical structure of ferrocene and ferrocene derivatives in the formation of the composites during hot pressing.

TABLE 1

| | Characteristics | | | |
|---|---|---|---|---|
| | R_{f}/R₀ | | | |
| | Ferrocene content | | | |
| | 20 | 30 | 40 | 50 |
| Composites | vol. % | vol. % | vol. % | vol. % |
| polypropylene - ferrocene | 140 | 280 | 590 | 850 |
| low-density polyethylene - | 155 | 310 | 650 | 960 |
| ferrocene | | | | |
| polyvinyl alcohol - ferrocene | 130 | 200 | 540 | 720 |
| polyvinylchloride - ferrocene | 6 | 16 | 83 | 210 |
| copolymer vinyliden chloride | 2 | 10 | 55 | 110 |
| with trifluoroethylene - ferrocene | | | | |

Negative internal effect is an increase of electrical resistance (i.e., decrease of conductivity) in the material under illumination conditions. Possible reasons of this effect in the composite material of the invention are the following:
1) Fast recombination of the charge carriers released by light with majority of basic carriers provided by dark current, where dark current is the relatively small electric current that flows through a photosensitive device when no photons are entering the device.
2) Decrease in mobility of the current carriers cause by their short-term sticking in traps, including those created by illumination.
3) Existence or formation of light-generated multiple charged centers that generate a local field that has intensity exceeding the intensity of the applied external field and that has a direction opposite to the direction of the applied external field.

The investigated materials are multiple-component systems which are combinations of polymeric dielectrics (that are used as phases for generation of charge-carrier traps) and ferrocenes or organic ferrocene derivatives (that are used as charge carrier initiator which, under the effect of incident light, initiate charge carriers, new traps, and short-term multiple-charge carrier centers).

Although the invention has been shown and described with reference to specific embodiments, it is understood that these embodiments should not be construed as limiting the areas of application of the invention and that any changes and modifications are possible provided that these changes and modifications do not depart from the scope of the attached patent claims.

1. A composite material with an electroconductivity photoquenching effect comprising: a multiple-component system comprising a combination of a polymeric material matrix and a ferrocene-type compound contained in the polymeric material matrix, wherein depending on the type of polymeric material matrix and content of the ferrocene-type compound, the electroconductivity photoquenching effect, which is represented by a R_{f}/R₀ ratio, where R_{f} is electrical resistance of the composite under illumination conditions, and R₀ is electrical resistance of the composite without illumination, may be as high as 960.

2. The composite material of claim 1, wherein the polymeric material matrix comprises a polymeric material selected from the group consisting of polypropylene, high-density polyethylene, low-density polyethylene, polyvinyl alcohol, polyvinyl chloride, polyvinylidene fluoride, and a copolymer of vinylidene chloride and trifluoroethylene.

3. The composite material of claim 1, wherein the polymeric material matrix comprises a polymeric material comprising a charge-trap initiator, and the ferrocene-based compound comprises a charge-carrier initiator.

4. The composite material of claim 2, wherein the polymeric material comprises a charge-trap initiator, and the ferrocene-based compound comprises a charge-carrier initiator.

5. The composite material of claim 1, wherein the ferrocene-type compound is selected from the group consisting of ferrocene and an oxygen-containing organic derivative of the ferrocene.

6. The composite material of claim 4, wherein the ferrocene-type compound is selected from the group consisting of ferrocene and an oxygen-containing organic derivative of the ferrocene.

7. The composite material of claim 1, wherein the ferrocene-type compound is contained in the composite in an amount of 10 vol. % to 50 vol. % per 100 vol. % of the polymeric material matrix.

8. The composite material of claim 7, wherein the ferrocene-type compound is selected from the group consisting of ferrocene and an oxygen-containing organic derivative of the ferrocene.

9. The composite material of claim 2, wherein the ferrocene-type compound is contained in the composite in an amount of 10 vol. % to 50 vol. % per 100 vol. % of the polymeric material matrix.

10. The composite material of claim 4, wherein the ferrocene-type compound is selected from the group consisting of ferrocene and an oxygen-containing organic derivative of the ferrocene.

11. The composite material of claim 1, wherein the ferrocene-type material is used in the form of particles having dimensions in the range of 5 to 20 μm.

12. The composite material of claim 9, wherein the ferrocene-type compound is used in the form of particles having dimensions in the range of 5 to 20 μm.

13. The composite material of claim 9, wherein with the content of ferrocene-type compound is contained in the composite in the range of 20 vol. % to 50 vol. % in the polymeric material matrix, wherein the polymeric material matrix comprises polypropylene and wherein the R_{f}/R₀ ratio, where R_{f} is electrical resistance of the composite under illumination, and R₀ is electrical resistance of the composite without illumination, is increased under illumination by a factor of 140 to 850.

14. The composite material of claim 9, wherein the ferrocene-type compound is contained in the composite in the range of 20 vol. % to 50 vol. % in the polymeric material matrix, wherein the polymeric material matrix comprises low-density polyethylene and wherein the R_{f}/R₀ ratio, where R_{f} is electrical resistance of the composite under illumination, and R₀ is electrical resistance of the composite without illumination, is increased under illumination by a factor of 155 to 960.

15. The composite material of claim 9, wherein the ferrocene-type compound is contained in the composite in the range of 20 vol. % to 50 vol. % in the polymeric material matrix, wherein the polymeric material matrix comprises polyvinyl alcohol and wherein the R_{f}/R₀ ratio, where R_{f} is electrical resistance of the composite under illumination, and R₀ is electrical resistance of the composite without illumination, is increased under illumination by a factor of 130 to 720.
